(19) United States
(12) Patent Application Publication
(10) Pub. No.: US 2014/0328051 A1
(43) Pub. Date: Nov. 6, 2014

(54) DISPLAY DEVICE

(71) Applicant: Sharp Kabushiki Kaisha, Osaka (JP)

(72) Inventors: Shinsuke Yokonuma, Osaka (JP); Kazunori Minoura, Osaka (JP)

(73) Assignee: SHARP KABUSHIKI KAISHA, Osaka (JP)

(21) Appl. No.: 14/357,179

(22) PCT Filed: Nov. 5, 2012
(86) PCT No.: PCT/JP2012/078567

§ 371 Date: May 8, 2014

(30) Foreign Application Priority Data
Nov. 11, 2011 (JP) 2011-247553

(51) Int. Cl. G02F 1/1333; G02F 1/1335

(52) U.S. Cl. CPC G02F 1/133308; G02F 1/133608; G02F 2001/133317
USPC 362/97.1; 361/679.01

(57) ABSTRACT

A liquid crystal display device 1 is provided with a liquid crystal display panel 10, which displays an image, and a case 2, which is disposed on the side of the liquid crystal display panel 10 opposite to the display surface side, and covers the side of the liquid crystal display panel 10 opposite to the display surface side. The case 2 includes a plurality of holes 3 that penetrate from the outside to the inside of the case 2, and edges of the holes 3 include projections 3a that protrude from the inner surface of the case 2 towards the inside thereof.

### TECHNICAL FIELD

The present invention relates to a display device that displays an image by radiating light on an object to be illuminated such as a liquid crystal display panel, for example.

### BACKGROUND ART

As display devices, liquid crystal display devices having liquid crystal display panels are widely used, and a conventional technique pertaining thereto is disclosed in Patent Document 1.

The conventional liquid crystal display device disclosed in Patent Document 1 includes a main liquid crystal panel as a display panel, a backlight that radiates light on the main liquid crystal panel, and a case that encloses the main liquid crystal panel and the backlight. The case encloses the backlight disposed opposite to the display surface side of the main liquid crystal panel while covering the region of the main liquid crystal panel opposite to the display surface side.

Here, a problem is that as liquid crystal display devices have become thinner in recent years, the strength of the liquid crystal display device has decreased as a result. There is an increased risk that, in mobile information devices such as mobile phones and PDAs, the liquid crystal display panels thereof receive damage due to a strong external force being applied thereto due to falls, pressure, or the like. The case in the conventional liquid crystal display device disclosed in Patent Document 1 is given protrusions and recesses, thereby increasing the strength of the liquid crystal display device.

### RELATED ART DOCUMENT

### Patent Document

Patent Document 1: Japanese Patent Application Laid-Open Publication No. 2007-171738

### SUMMARY OF THE INVENTION

### Problems to be Solved by the Invention

However, while increased strength and lighter weight are in demand for recent display devices, the conventional display device does not address the reduction of weight. Thus, there was a possibility that reducing the weight of the display device by adding protrusions and recesses to the case in order to the increase the strength thereof is not possible.

The present invention takes into account the above-mentioned problem, and an object thereof is to provide a display device for which it is possible to simultaneously increase the strength and decrease the weight thereof.

### Means for Solving the Problems

In order to solve the above-mentioned problems, a display device of the present invention includes: a display panel that displays an image; and a case that is disposed on a side of the display panel opposite to a display surface side thereof, the case covering the side of the display panel opposite to the display surface side, wherein the case has formed therein a plurality of holes that penetrate the case from outside the case to inside the case with edges of the holes having projections that protrude from an inner surface of the case towards an interior of the case.

According to this configuration, the case of the display device includes a plurality of holes and thus the weight is reduced. Furthermore, the edges of the holes in the case of the display device have projections, thus increasing the resistance of the case to bending, warping, and the like. Here, the “display surface” refers to the surface of the display panel that displays images and the like.

In the display device configured as described above, each of the projections is bent outward in a radial direction of each of the holes such that tips of the projections face the inner surface of the case.

According to this configuration, the tips of the projections are rolled towards the inner surface of the case, for example, which further increases the resistance of the case of the display device to bending, warping, and the like.

In the display device configured as described above, an illumination unit that is disposed between the display panel and the case and that radiates light towards the display panel is further included, wherein the projections are in contact with a surface of the illumination unit facing the case.

Although there is a risk that providing projections would result in a gap between the illumination unit and the inner surface of the case, according to this configuration, the surface of the illumination unit facing the case is supported by the projections. As a result, thermal expansion in the surface of the illumination unit facing the case is mitigated.

In the display device configured as described above, a substrate that is disposed inside the case and that exchanges signals with the display panel is further included, wherein the projections are in contact with a surface of the illumination unit facing the case.

According to this configuration, the substrate and the case are electrically connected. As a result, a grounding terminal of the substrate is electrically connected to the case.

In the display device configured as described above, the case is made of sheet metal and the projections are made by curling the sheet metal.

According to this configuration, holes can be formed with ease in the case made of sheet metal, and the projections can be formed with ease by curling.

### EFFECTS OF THE INVENTION

According to the configuration of the present invention, the case of the display device includes a plurality of holes and projections in the edges of the holes, and thus, the weight is reduced while resistance to bending, warping, and the like is strengthened. Thus, it is possible to provide a display device in which it is possible to simultaneously increase the strength and decrease the weight.

### BRIEF DESCRIPTION OF THE DRAWINGS

FIG. 1 is an exploded perspective view of a liquid crystal display device (display device) according to Embodiment 1 of the present invention.

FIG. 2 is a magnified perpendicular cross-sectional view showing a portion of the liquid crystal display device according to Embodiment 1.

FIG. 3 is a bottom view of the liquid crystal display device according to Embodiment 1.

FIG. 4 is a magnified perpendicular cross-sectional view showing a portion of a case of the liquid crystal display device according to Embodiment 1.

FIG. 5 is a bottom view of a liquid crystal display device according to Embodiment 2 of the present invention.

### DETAILED DESCRIPTION OF EMBODIMENTS

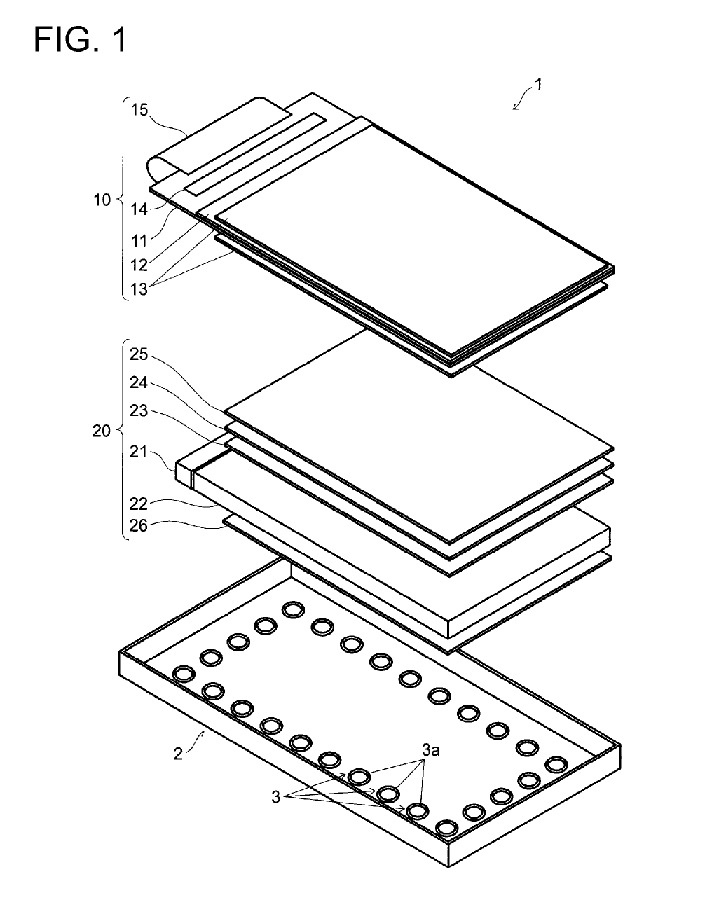

Embodiments of the present invention will be described below with reference to FIGS. 1 to 5. Here, a liquid crystal display device will be described as an example of a display device of the present invention.

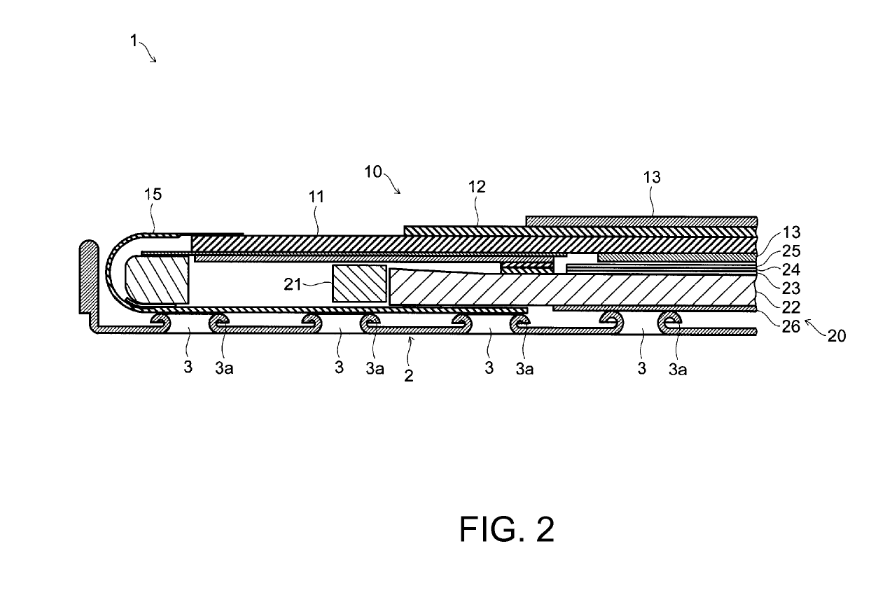

First, the overall structure of a liquid crystal display device of Embodiment 1 of the present invention will be described with reference to FIGS. 1 and 2. FIG. 1 is an exploded perspective view of the liquid crystal display device, and FIG. 2 is a magnified perpendicular cross-sectional view of a portion of the liquid crystal display device. The upper side of FIGS. 1 and 2 is the display surface side of the liquid crystal display panel described later.

A liquid crystal display device 1 is a display device that uses liquid crystal to display images, and has a substantially rectangular shape in a plan view that is longer in the left-and-right direction. The liquid crystal display device 1 includes a liquid crystal display panel 10 as a display panel and a backlight unit 20 that is an illumination unit as shown in FIGS. 1 and 2. The liquid crystal display panel 10 and the backlight unit 20 are supported by a case 2.

The liquid crystal display panel 10 includes an active matrix substrate 11, a color filter substrate 12 and polarizing plates 13. The color filter substrate 12 is sometimes simply referred to as an opposite substrate.

The active matrix substrate 11 is disposed opposite to the color filter substrate 12 disposed on the display surface side of the liquid crystal display panel 10. The active matrix substrate 11 includes, on a prescribed surface thereof, switching elements made of TFTs (thin film transistors), pixel electrodes, and common electrodes, which are not shown. The pixel electrodes and the common electrodes are interdigital electrodes that form pairs.

The active matrix substrate 11 and the color filter substrate 12 are respectively covered by alignment films (not shown) that have prescribed respective surfaces that orient the liquid crystal in a specific direction.

The active matrix substrate 11 and the color filter substrate 12 are bonded together by a sealing member (not shown) such that the prescribed surfaces thereof face each other. Liquid crystal is sandwiched between the active matrix substrate 11 and the color filter substrate 12, and is sealed in the space surrounded by the sealing member.

The polarizing plates 13 are bonded to respective surfaces of the active matrix substrate 11 and the color filter substrate 12, the surfaces being opposite to the prescribed surfaces where the liquid crystal is sealed. The polarizing plates 13 are sheets through which only light waves oscillating in a specific direction are allowed through, and the two polarizing plates 13 are respectively bonded such that the transmission axes thereof are offset by approximately 90°.

A control circuit 14 is provided outside of the area where the active matrix substrate 11 and the color filter substrate 12 face each other. The control circuit 14 controls an electric field generated between the pixel electrodes and the common electrodes on the basis of an image signal in order to adjust the orientation of the liquid crystal.

The control circuit 14 has a flexible printed circuit board 15 provided on the outside thereof. The flexible printed circuit board 15 bends in order to electrically connect the liquid crystal display panel 10 and the backlight unit 20, and extends from the display surface side of the liquid crystal display panel 10 to the inner side of the case 2. The flexible printed circuit board 15 transfers signals between the liquid crystal display panel 10, the backlight unit 20, and the like.

The liquid crystal display panel 10 configured in this manner adjusts the orientation of the liquid crystal by an electric field generated between the pixel electrodes and the common electrodes in the active matrix substrate 11 on the basis of an image signal, thus changing the transmittance of light through the liquid crystal layer. The liquid crystal display panel 10 is of a transverse field type as described above, for example, and causes liquid crystal molecules to rotate within a plane parallel to the main substrate surface by generating an electric field parallel to the main surface of the active matrix substrate 11.

The backlight unit 20 is a module for emitting backlight for the liquid crystal display panel 10, and is an edge-lit illumination device, for example. The backlight unit 20 is disposed on the rear surface side (lower side in FIGS. 1 and 2) of the liquid crystal display panel 10 housed within the case 2. The backlight unit 20 includes a light-emitting portion 21, a light guide plate 22, a diffusion plate 23, a prism sheet 24, a lens sheet 25, and a reflective sheet 26.

The light-emitting portion 21 includes a plurality of white LEDs (light emitting diodes) that emit white light, for example. The plurality of LEDs are disposed along a side of the light guide plate 22 such that the light-emitting direction thereof faces one edge face of the light guide plate 22. The edge face of the light guide plate 22 mentioned here is a face formed so as to be substantially perpendicular to the upper main surface of the light guide plate 22, which is a main surface, that faces the surface of the liquid crystal display panel 10 opposite to the display surface, or in other words, the rear surface of the liquid crystal display panel 10. Also, LEDs are not limited to those that emit white light, and light sources other than LEDs may be used for the light-emitting portion 21. The light-emitting portion 21 may be disposed facing two or more edge faces of the light guide plate 22.

The light guide plate 22 is substantially rectangular in a plan view, and is made of a transparent resin such as acrylic or polycarbonate. The light guide plate 22 receives light radiated from the light-emitting portion 21 at one of the four edge faces. In the light guide plate 22, the upper main surface, which is substantially perpendicular to the edge face receiving light from the light-emitting portion 21 and is a main surface facing the rear surface of the liquid crystal display panel 10, radiates light towards the liquid crystal display device 10.

The diffusion plate 23, the prism sheet 24, and the lens sheet 25 are disposed on the upper main surface of the light guide plate 22 so as to cover the light guide plate 22 from the liquid crystal display panel 10 side.

Among the diffusion plate 23, the prism sheet 24, and the lens sheet 25, the diffusion plate 23 is disposed closest to the light guide plate 22, and directly receives light radiated from the light guide plate 22. The diffusion plate 23 is disposed such that the light-receiving surface that receives light from the light guide plate 22 faces the upper main surface of the light guide plate 22. The diffusion plate 23 diffuses light received from the light guide plate 22, and causes the light to spread across the entire liquid crystal display panel 10.

The prism sheet 24 is disposed on the diffusion plate 23, towards the liquid crystal display panel 10. The prism sheet 24 has triangular prisms, for example, that extend in a linear fashion in one direction and are aligned in a direction that intersects the one direction in the sheet surface. The prism sheet 24 polarizes the radiating characteristics of light from the diffusion plate 23.

The lens sheet 25 is provided on the prism sheet 24, towards the liquid crystal display panel 10. The lens sheet 25 has spread therein microparticles that refract and disperse light. The lens sheet 25 mitigates differences in brightness that are variations in amount of light without causing light from the prism sheet 24 to concentrate in one area.

On the other hand, the reflective sheet 26 is disposed on the lower main surface of the light guide plate 22 so as to cover the light guide plate 22 from the side thereof opposite to the liquid crystal display panel 10. The reflective sheet 26 reflects some of the light that might otherwise be emitted from the lower main surface of the light guide plate 22 back towards the upper main surface of the light guide plate 22. The reflective sheet 26 increases the brightness of the light guide plate 22.

The backlight unit 20 having such a configuration emits an even planar backlight so as to illuminate the rear surface of the liquid crystal display panel 10. The liquid crystal display panel 10 changes the transmittance of backlight passing through the liquid crystal on the basis of the image signal, and thus, a desired image is displayed on the display surface of the liquid crystal display panel 10.

The case 2 is made of sheet metal, and is formed into a box shape forming a substantially rectangular shape in a plan view, with an open top. The case 2 includes a liquid crystal display panel 10 in the vicinity of the opening, is disposed on the side of the liquid crystal display panel 10 opposite to the display surface side so as to cover the side of the liquid crystal display panel 10 opposite to the display surface side. The interior of the case 2, or in other words, the inner bottom surface houses the backlight unit 20.

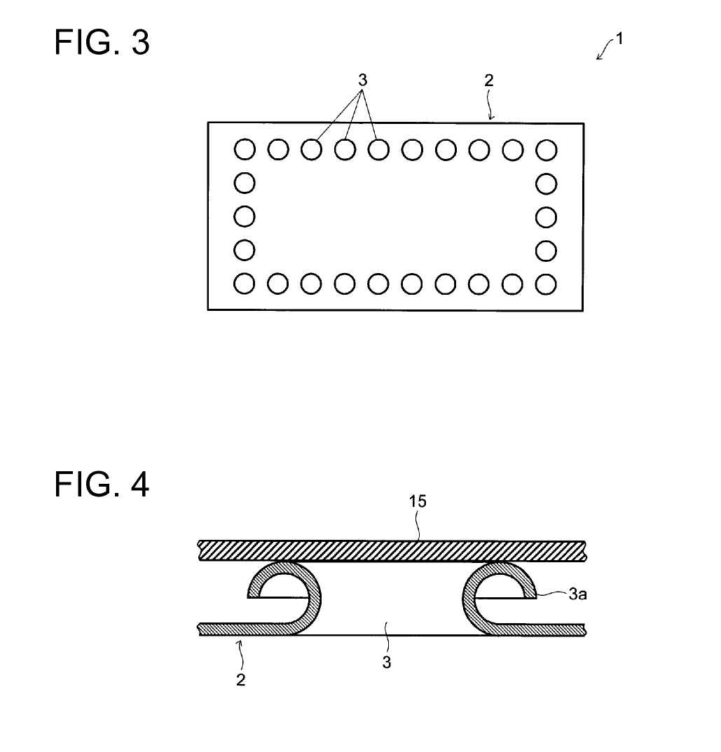

Next, a detailed configuration of the case 2 will be described with reference to FIGS. 1 to 4. FIG. 3 is a bottom view of the liquid crystal display device 1, and FIG. 4 is a magnified perpendicular cross-sectional view of a portion of the case 2 of the liquid crystal display device 1.

The case 2 has a plurality of holes 3 formed in the bottom thereof as shown in FIGS. 1 and 2. The holes 3 are circular, and penetrate from the outside to the inside of the case 2. The plurality of holes 3 are aligned in a rectangular shape along the edges of the rectangular case 2 as shown in FIG. 3.

In the edges of the respective holes 3, projections 3a are provided as shown in FIGS. 1, 2, and 4. The projections 3a protrude towards the inner side from the inner surface of the case 2. In addition, tips of the projections 3a bend towards the outside the holes 3 in the radial direction so as to face the inner surface side of the case 2. The case 2 is made of sheet metal, and thus, the projections 3a are formed by curling the sheet metal.

As shown in FIGS. 2 and 4, the projections 3a of some of the holes 3 have edges that are in contact with a surface of the flexible printed circuit board 15 facing the case 2, the edges being furthest inside the case 2. Also, as shown in FIG. 2, some of the projections 3a of the holes 3 have edges that are in contact with a surface of the backlight unit 20 facing the case 2, or in other words the reflective sheet 26, the edges being furthest inside the case 2.

As described above, the case 2 of the liquid crystal display device 1 includes a plurality of holes 3 that penetrate from the outside to the inside of the case 2, and edges of the holes 3 include projections 3a that protrude from the inner surface towards the inside. The case 2 has a reduced weight due to the plurality of holes 3, and due to the holes 3 having projections 3a on the edges thereof, the case 2 is more resistant to bending, warping, and the like. Thus, it is possible to simultaneously increase the strength and decrease the weight of the liquid crystal display device 1.

Furthermore, the tips of the projections 3a are bent towards the outside of the holes 3 in the radial direction so as to face the inner surface of the case 2, and by rolling the tips towards the inner surface of the case 2 as described above, the case 2 is further strengthened so as to resist bending, warping, and the like.

By providing the projections 3a, there is a risk that a gap would form between the backlight unit 20 and the inner surface of the case 2. However, by having the projections 3a be in contact with the surface of the backlight unit 20 facing the case 2, or in other words, the reflective sheet 26, the one surface of the reflective sheet 26 of the backlight unit 20 can be supported. Thus, it is possible to mitigate thermal expansion in the reflective sheet 26. Therefore, wrinkling in the reflective sheet 26 is prevented, thus preventing a decrease in brightness in the backlight unit 20.

The projections 3a are also in contact with a surface of the flexible printed circuit board 15 facing the case 2, and thus, the case 2 and the flexible printed circuit board 15 are electrically connected. Thus, it is possible to electrically connect a grounding terminal (not shown) of the flexible printed circuit board 15 to the case 2. Therefore, it is possible to stabilize the operation of the control circuit.

Also, in the liquid crystal display device 1, the case 2 is made of sheet metal 2 and the projections 3a are formed by curling up the sheet metal. In other words, the holes 3 can be made to penetrate the case 2 made of the sheet metal with ease, and the projections 3a can be formed in a simple manner by curling.

According to the configuration of the embodiment of the present invention above, the case 2 of the liquid crystal display device 1 has a plurality of holes 3 and projections 3a provided in the edges of the holes 3, thus reducing the weight and increasing resistance to bending, warping, and the like. Thus, it is possible to provide the liquid crystal display device 1 in which it is possible to simultaneously increase the strength and decrease the weight.

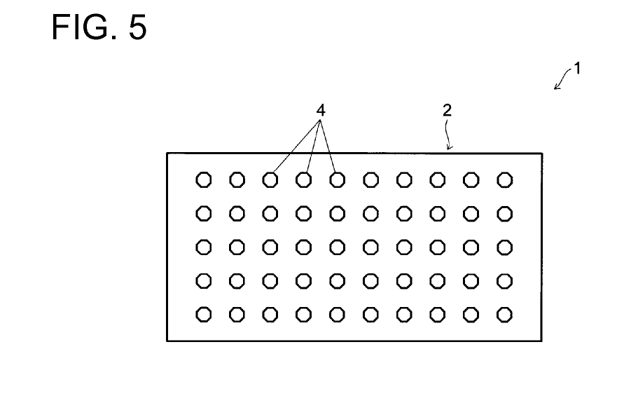

Next, a liquid crystal display device according to Embodiment 2 of the present invention will be described with reference to FIG. 5. FIG. 5 is a bottom view of the liquid crystal display device. The basic configuration of the present embodiment is the same as that described in Embodiment 1 with reference to FIGS. 1 to 4, and thus, components in common with Embodiment 1 are assigned the same reference characters, and drawings and descriptions thereof will be omitted.

A case 2 in a liquid crystal display device 1 of Embodiment 2 includes a plurality of holes 4 in the bottom thereof as shown in FIG. 5. The holes 4 are polygonal, that is octagonal, and penetrate from the outside to the inside of the case 2. The plurality of holes 4 are substantially arranged in a grid pattern throughout the entire bottom surface of the rectangular case 2. The edges of the respective holes 4 are provided with projections (not shown) that protrude from the inner surface of the case 2 towards the inside.

As described above, even if the plurality of holes 4 provided in the case 2 are octagonal, the weight can be reduced by provided the case 2 with the plurality of holes 4, and by provided projections in the edges of the holes 4, the case 2 can be strengthened to increase resistance from bending, warping, and the like, as in Embodiment 1. Thus, it is possible to simultaneously increase the strength and decrease the weight of the liquid crystal display device 1.

Embodiments of the present invention were described above, but the scope of the present invention is not limited thereto, and can be implemented with various modifications without departing from the spirit thereof.

For example, in the embodiments of the present invention, the holes 3 or 4 provided in the case 2 were circular or octagonal, but the shape of the holes is not limited thereto, and may have another type of polygonal shape or an elliptical shape. Also, the case 2 may include holes of a plurality of different shapes.

In addition, in the embodiments of the present invention, the holes 3 or 4 are arranged in a rectangular shape or in a grid pattern on the bottom surface of the case 2, but the holes are not limited to being disposed in these arrangements, and may have another arrangement such as being disposed at random, for example. Also, the size and number of holes 3 and 4 are not limited to the size and number in the embodiments above, and the holes may be of a plurality of sizes and shapes, for example.

### INDUSTRIAL APPLICABILITY

The present invention can be used a display device that displays an image by radiating light on an object to be illuminated such as a liquid crystal display panel, for example.

### DESCRIPTION OF REFERENCE CHARACTERS

1 liquid crystal display device (display device)
2 case
3, 4 hole
3a projection
10 liquid crystal display panel (display panel)
15 flexible printed circuit board (substrate)
20 backlight unit (illumination part)
26 reflective sheet

1. A display device, comprising:
a display panel that displays an image; and
a case that is disposed on a side of the display panel opposite to a display surface side thereof,
wherein the case has formed therein a plurality of holes that penetrate the case with edges of the holes having projections that protrude from an inner surface of the case towards an interior of the case.

2. The display device according to claim 1, wherein each of the projections is bent outward in a radial direction of each of the holes such that tips of the projections face the inner surface of the case.

3. The display device according to claim 1, further comprising an illumination unit that is disposed between the display panel and the case and that radiates light towards the display panel,
wherein the projections are in contact with a surface of the illumination unit facing the case.

4. The display device according to claim 1, further comprising a substrate that is disposed inside the case and that exchanges signals with the display panel,
wherein the projections are in contact with a surface of the substrate facing the case.

5. The display device according to claim 1, wherein the case is made of sheet metal and the projections are made by curling the edges of the holes formed in the sheet metal.
